(19) United States
(12) Patent Application Publication
(10) Pub. No.: US 2015/0046857 A1
(43) Pub. Date: Feb. 12, 2015

(54) DISPLAYING AND EXECUTING OPERATION ASSISTANCE PROGRAM

(71) Applicant: SHIMADZU CORPORATION, Kyoto-shi (JP)

(72) Inventor: Takayuki KIHARA, Kyoto-shi (JP)

(73) Assignee: SHIMADZU CORPORATION, Kyoto-shi (JP)

(21) Appl. No.: 14/336,047

(22) Filed: Jul. 21, 2014

(30) Foreign Application Priority Data
Aug. 9, 2013 (JP) 2013-165778

(51) Int. Cl. G06F 3/0484

(52) U.S. Cl. CPC G06F 3/04842
USPC 715/765

(57) ABSTRACT

Provided is a program for giving an additional GUI to various software products. The program makes a computer function as: a reference image detector for detecting, within a base GUI displayed on a monitor, a detection image which is an image that matches the reference image, and for determining the display position of this image; a target software identifier for identifying, based on the detection image and/or information on the display position of the detection image, a target software program showing the detection image; an additional GUI displayer for superposing the image of the additional GUI component at the display position designated for the additional GUI component; and a command executer for performing, on the target software program, the operation performed by the additional GUI component, with reference to the additional GUI information storage section, in response to an input operation performed on the additional GUI component by the user.

### TECHNICAL FIELD

The present invention relates to a computer program for assisting an operation of a software product by means of a graphical user interface (GUI).

### BACKGROUND ART

Software products designed for public use should have a user interface devised for allowing users to easily enter commands.

For example, consider the operation of saving the state of a software program at a certain point in time. One of the most basic methods is to type in the “save” command. Although this way of command entry is reliable, a problem exists in that users need to have previous knowledge of, or search for information on, every command that they want to enter.

In the case of Microsoft Windows™ or similar operating systems (OS), the “save” command is typically entered as follows: Initially, the user selects the “File” menu displayed in the upper area of a window by manipulating a mouse, keyboard or other input devices, whereupon a list of operations that can be selected under the “File” menu is displayed on the computer screen. Then, the user moves an arrow pointer or similar object on the screen and selects (“clicks”) the desired command on the list, whereupon the “save” process is executed.

In another typical method, a GUI button for executing the “save” operation (e.g. an “icon” which imitates a flexible disk) is displayed at a predetermined position within or near the window. When the user presses the button by manipulating the mouse, the “save” process is executed.

For such operations that are frequently used or that will be more comprehensible to users if presented in visual forms, an appropriately designed GUI dramatically improves the user-friendliness of the operations.

One of the technical fields in which the provision of a GUI is effective for improving the user-friendliness of a software product is the field of measurement and analysis.

In recent years, the task of controlling an analyzing or measurement device (such as a chromatographic analyzer or spectrophotometric analyzer), as well as the task of processing and managing analysis data collected as a result of an analysis, have been performed with an analyzing device control system externally connected to the device (for example, see Patent Literature 1). Typically, the substance of such an analyzing device control system is a multi-purpose computer (which is hereinafter appropriately abbreviated as the “PC”) having a variety of functions realized by executing a specifically provided software program (which is hereinafter called the control software).

Operations of such control software have been increasingly complex. In particular, when performing an analysis or measurement, users need to enter various parameters and commands. However, it is not always the case that every user who needs to operate the control software is familiar with all the commands. Therefore, it is preferable to provide the control software with a GUI so that users can intuitively perform various operations.

### CITATION LIST

### Patent Literature

Patent Literature 1: JP 2004-37374 A

### SUMMARY OF INVENTION

### Technical Problem

To provide a certain software program with an additional GUI, it is necessary to directly modify that program. However, this approach has the following problems:

Modifying a software program requires an open source code or application programming interfaces available for modifying the program. However, most of the currently marketed software products have neither open source codes nor externally accessible application programming interfaces. In particular, modifying a control software program designed for an analyzing or measurement device is normally prohibited due to the need to ensure that the system is secure and can perform an analysis with high reliability.

Even in the case where a GUI can be added to a software program, it is often the case that the GUI components can be placed at limited locations on the screen (window). Basically, it is impossible or difficult to add GUI components at desired locations on the screen.

The problem to be solved by the present invention is to provide a program through which a desired GUI component can be displayed at an arbitrary position.

### Solution to Problem

The present invention aimed at solving the previously described problems is a displaying and executing operation assistance program for assisting an operation of one or a plurality of software programs having a base graphical user interface (GUI) displayed on a screen, the assistance program being designed to display an additional GUI component on the screen and allow an operation of a computer to be executed through the additional GUI component, the computer being capable of accessing an additional GUI information storage section in which a reference image, an image of the additional GUI component, information on a display position designated for the additional GUI component, and an operation to be performed by the additional GUI component are stored, and the assistance program making the computer function as:

a) a reference image detector for detecting, within the base GUI displayed on the screen, a detection image which is an image that matches the reference image, and for determining the display position of the detection image;

b) a target software identifier for identifying, based on the detection image and/or information on the display position of the detection image, a target software program which is the software program showing the detection image;

c) an additional GUI displayer for superposing the image of the additional GUI component at the display position designated for the additional GUI component, with reference to the additional GUI information storage section, when the detection image is detected; and

d) a command executer for performing, on the target software program, the operation performed by the additional GUI component, with reference to the additional GUI information storage section, in response to an input operation performed on the additional GUI component by a user.

The reference image detector may employ any method by which a detection image (i.e. an image identical to the reference image) shown on the display screen can be located and the display position of the detection image on the display screen can be determined.

The designated display position at which the image of the additional GUI component is to be displayed by the additional GUI displayer may be expressed as a relative position with respect to the display position of the detection image or an absolute position within the display screen.

### Advantageous Effects of the Invention

With the displaying and executing operation assistance program according to the present invention, even a software program whose source code is not open can have an additional GUI component provided at a desired position on the screen.

### BRIEF DESCRIPTION OF DRAWINGS

FIG. 1 is a schematic configuration diagram of a system on which a displaying and executing operation assistance program as the first embodiment of the present invention is running.

FIG. 2 is a reference image stored in an additional GUI information storage section.

FIG. 3 is a flowchart of an operation of the displaying and executing operation assistance program according to the first embodiment.

FIG. 4 shows detection images included in a desktop image.

FIG. 5 shows an example of the additional GUI superposed on a window.

FIG. 6 shows another example of the additional GUI superposed on a window.

FIG. 7 shows still another example of the additional GUI superposed on a window.

FIG. 8 is a schematic configuration diagram of a system including a displaying and executing operation assistance program according to the second embodiment of the present invention.

FIG. 9 is a display example showing an operation to enter a command for initiating an operation guide.

FIG. 10 is a flowchart showing an operation of the displaying and executing operation assistance program according to the second embodiment.

FIG. 11 is a display example of the first stage of the operation guide.

FIG. 12 is a display example of the second stage of the operation guide.

FIG. 13 is a display example of the third stage of the operation guide.

FIG. 14 is a display example of the fourth stage of the operation guide.

FIG. 15 is a display example of the fifth stage of the operation guide.

FIG. 16 is a display example of the sixth stage of the operation guide.

FIG. 17 is a display example of the seventh stage of the operation guide.

FIG. 18 is an example of the step-control panel of the operation guide.

FIG. 19 shows an example in which the additional GUI components corresponding to a plurality of stages of the operation guide are simultaneously displayed.

FIG. 20 is a display example of the operation guide.

### DESCRIPTION OF EMBODIMENTS

Embodiments of the displaying and executing operation assistance program according to the present invention are hereinafter described in detail with reference to the attached drawings.

### First Embodiment

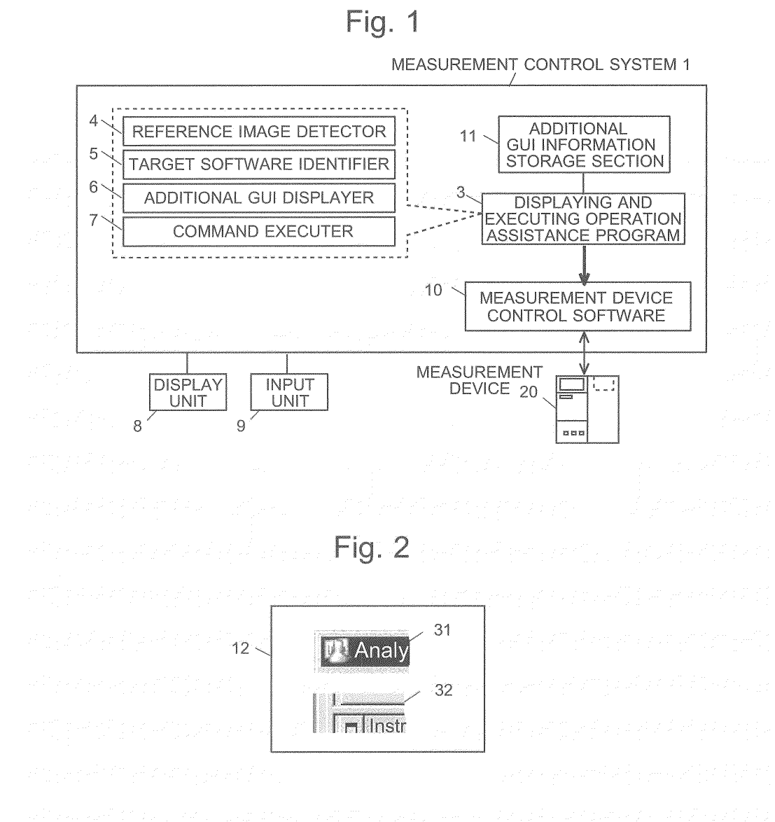

FIG. 1 is a schematic configuration diagram of a system on which a displaying and executing operation assistance program as the first embodiment of the present invention is running.

The measurement control system 1, which is connected to a measurement device 20 (e.g. a liquid chromatograph), controls an operation of the measurement device 20 and analyzes the result of a measurement performed with the measurement device 20.

The substance of the measurement control system 1 is a multi-purpose computer (PC) composed of various hardware components, including a central processing unit (CPU), a memory, and a mass-storage device which consists of a hard disk drive (HDD) or solid state drive (SSD). An operating system (OS), such as the Windows™ OS, is running on the measurement control system 1, on which the measurement device control software 10 is executed.

A display unit 8 including a liquid crystal display and other components, which is used for displaying various kinds of information, and an input unit 9 including a mouse and a keyboard, with which users can enter various commands, are connected to the measurement control system 1. Although the display unit 8 and the input unit 9 are depicted as external components to the measurement control system 1 in FIG. 1, these units 8 and 9 will be physically integrated in the measurement control system 1, for example, if the measurement control system 1 is built on a tablet PC.

The displaying and executing operation assistance program 3, which is provided in the measurement control system 1 (i.e. it is installed on the PC), performs operations on the measurement device control software 10.

The configuration of the displaying and executing operation assistance program 3 is hereinafter described. The displaying and executing operation assistance program 3 consists of a reference image detector 4, a target software identifier 5, an additional GUI displayer 6 and a command executer 7. The reference image detector 4, the target software identifier 5, the additional GUI displayer 6 and the command executer 7 are realized as software components on the measurement control system 1 (PC).

The measurement control system 1 also includes an additional GUI information storage section 11, which is accessible from the displaying and executing operation assistance program 3. The additional GUI information storage section 11 does not need to be provided inside the measurement control system 1; it can be at any location accessible from the displaying and executing operation assistance program 3.

For example, the additional GUI information storage section 11 is provided on a portion of the aforementioned mass-storage device and holds various items of information related to the additional GUI. Specifically, it holds the following items of information:
Reference image (which will be described later)
Image of additional GUI component (which may be any kind of visual element, such as an arrow, button or character; there is no limitation on its shape or appearance)
Information on the display position designated for the additional GUI component (e.g. a piece of information which indicates the position at which the additional GUI component should be placed with respect to the window of the measurement device control software 10 displayed on the display unit 8)
An operation to be performed for the measurement device control software 10 when an execution command has been entered for the additional GUI component through the input unit 9. This operation may be directed at the measurement device control software 10 or at the computer on which the measurement device control software 10 is running. A plurality of operations may be combined. Two or more operations may be associated with one additional GUI image. For example, an additional GUI image of up-down arrows may have one operation associated with the up arrow and another operation associated with the down arrow.

The reference image stored in the additional GUI information storage section 11 is an image showing a partial area that is always included in the GUI of the measurement device control software 10 (this GUI includes the execution window itself). For example, the image showing a partial area may be a predetermined range including the upper-left corner of the execution window of the measurement device control software 10 (e.g. an image of an area including a character string showing the application name of the measurement device control software 10 running on the OS), or an image of a splitter for dividing an area within the execution window of the measurement device control software 10 (this window is hereinafter called the “measurement device control software window”). There may be two or more reference images.

FIG. 2 shows a first reference image 31 and a second reference image 32, which are the reference images stored in the additional GUI information storage section 11 in the present embodiment. The first reference image 31 is an image showing the upper-left corner of the measurement device control software window, while the second reference image 32 is an image including a splitter dividing an area within the measurement device control software window.

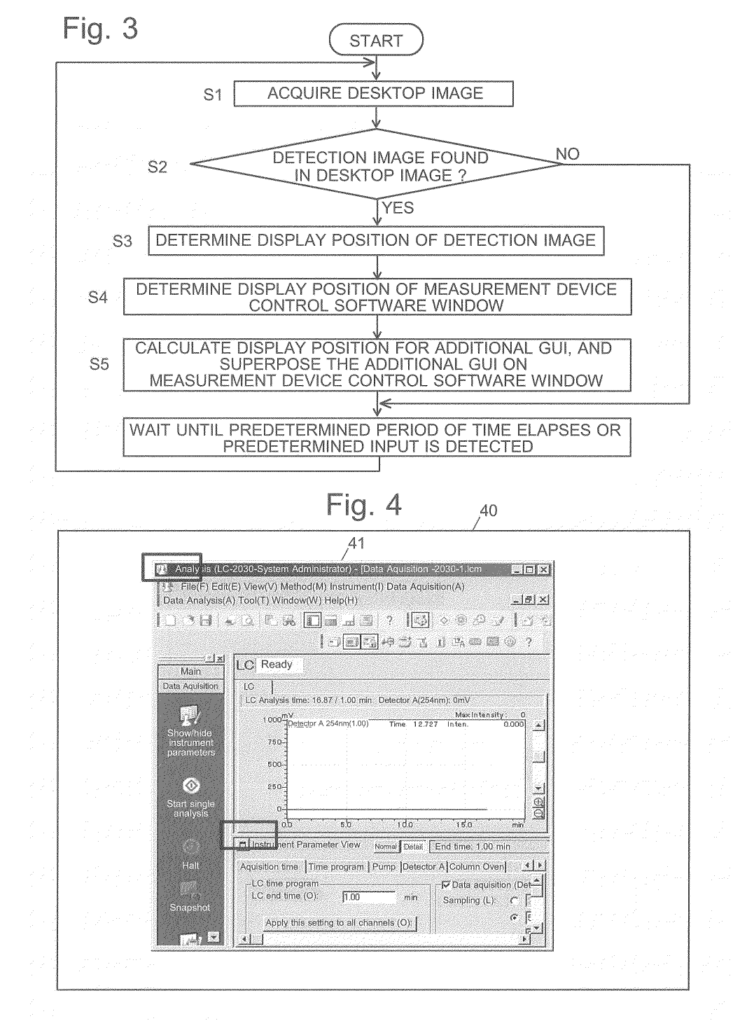

An operation of the displaying and executing operation assistance program 3 is hereinafter described with reference to the flowchart shown in FIG. 3.

(Start) The displaying and executing operation assistance program 3 should preferably be designed so that it is automatically executed, for example, upon execution of the measurement device control software 10. It may also be designed as a program that is always active on the computer on which the measurement control system 1 is running, or a program that is executed in response to an entry of a certain command.

(Step S1) The reference image detector 4 acquires a desktop image 40 of the display unit 8 (i.e. an image of the entire desktop). FIG. 4 shows one example of the acquired desktop image 40.

(Step S2) Next, the reference image detector 4 performs a matching process for determining whether or not the desktop image 40 includes “detection images”, i.e. the partial images which respectively match the first and second reference images 31 and 32 stored in the additional GUI information storage section 11. When the detection images have been found, the reference image detector 4 determines their display positions (Step S3). The matching process may be achieved by any technique. For example, an image matching, pattern recognition or character recognition can be used.

If none of the detection images has been found in the desktop image 40 by the reference image detector 4 (“NO” in Step S2), the measurement device control software window cannot be located on the display unit 8. In such a case, the displaying and executing operation assistance program 3 temporarily halts its process and then resumes its operation after a predetermined period of time or at a predetermined timing.

In the present example, the reference image detector 4 detects the detection images corresponding to the first and second reference images 31 and 32 in the desktop image 40, as indicated by the rectangles in FIG. 4 (“YES” in Step S2), and determines their display positions (Step S3), after which the process goes to Step S4.

(Step S4) Based on the information on the display positions of the detection images obtained as a result of Steps S2 and S3, the target software identifier 5 determines the measurement device control software window 41 on which the detection images are displayed. The “display position” may be a position (coordinates) on the display unit 8 (this information is provided by the OS, for example) or a position (coordinates) on the measurement device control software window 41 (on the display unit 8).

By using an image unique to the target software as the detection target images (the first reference image), or by using a plurality of reference images, the target software window can be easily located.

(Step S5) Based on the information on the display position designated for the additional GUI component in the additional GUI information storage section 11, the additional GUI displayer 6 calculates the position at which the additional GUI component is to be displayed on the display unit 8 and superposes the additional GUI component at the calculated position on the measurement device control software window 41. Naturally, there may be two or more GUI components.

The position calculated by the additional GUI displayer 6 for the additional GUI component to be displayed on the display unit 8 may be expressed in absolute coordinates on the display unit 8 or in relative coordinates with respect to a certain position, such as the position (coordinates) of the detection image corresponding to the first or second reference image 31 or 32 or a specific point on the measurement device control software window 41 (e.g. the upper-left corner of this window 41). It is also possible to obtain information on the layout of the measurement device control software window 41 or perform an image analysis on the measurement device control software window 41 (e.g. to recognize a black frame within the screen). By using one or more of these various techniques independently or in combination, the additional GUI displayer 6 calculates the display position for the additional GUI component.

The additional GUI component does not need to be completely superposed on the measurement device control software window 41; it may be partially superposed on or separately positioned near this window 41.

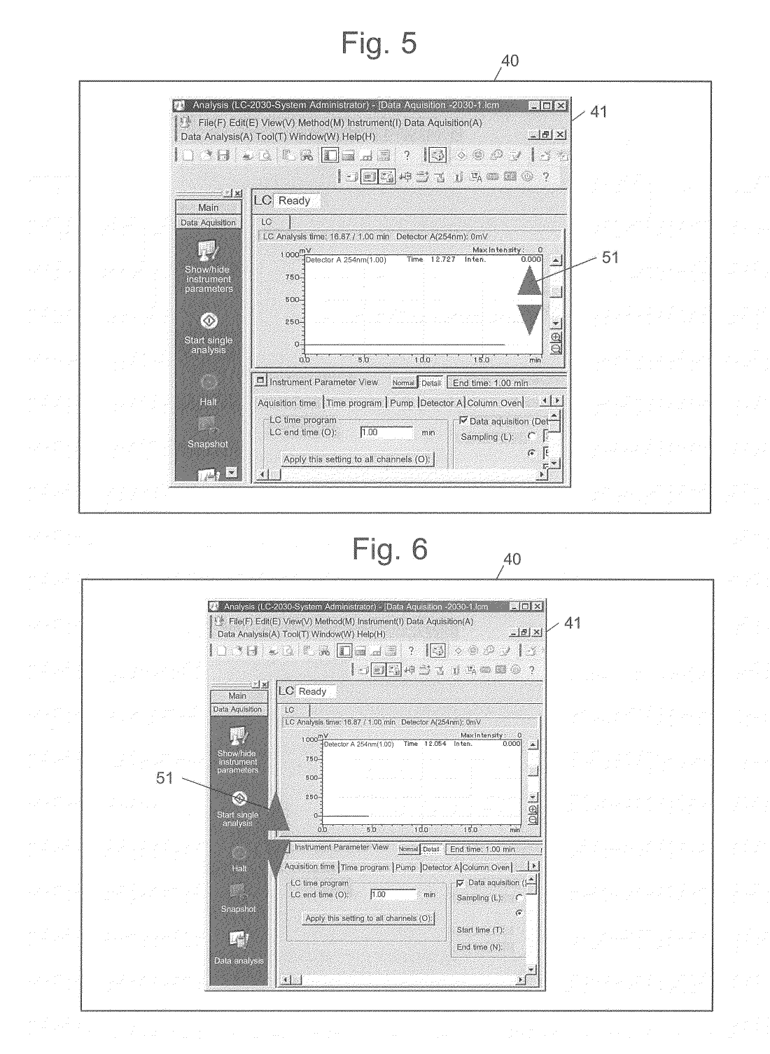

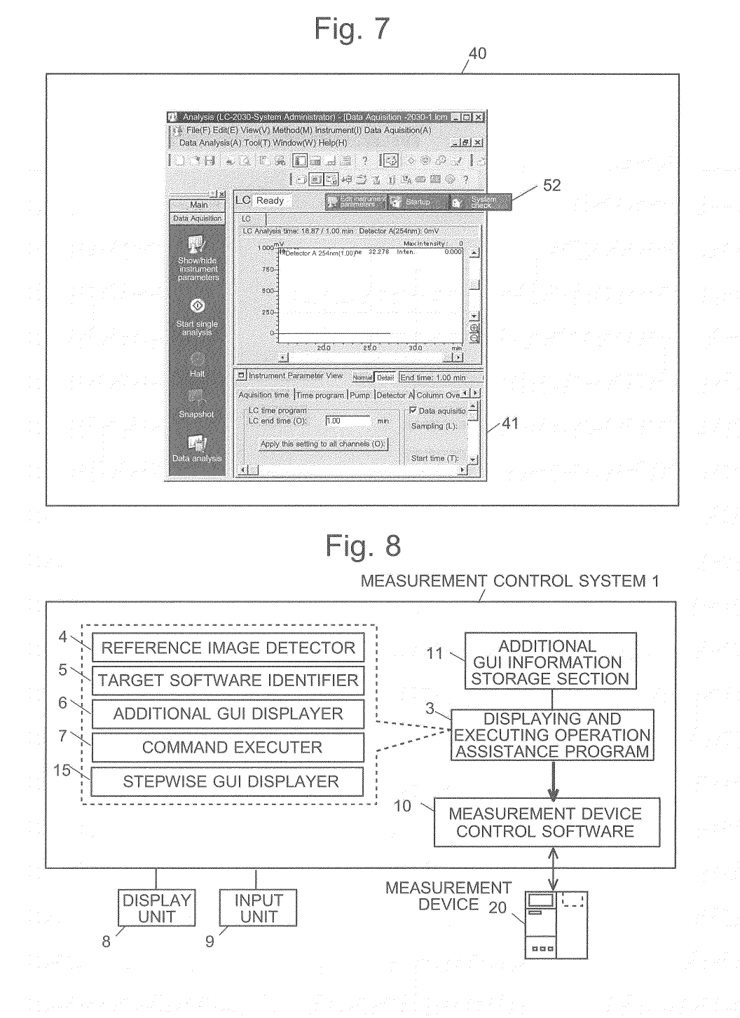

FIGS. 5-7 show examples of the screen on which additional GUI components are superposed on the measurement device control software window 41 within the display unit 8. In the example of FIG. 5, up-down arrows 51 are superposed as the additional GUI component. In the example of FIG. 6, the up-down arrows 51 are superposed at a position different from the example of FIG. 5. In the example of FIG. 7, a command set 52 with the three commands of “Edit instrument parameters”, “Startup” and “System check” is displayed as the additional GUI component.

After the process of Step S5 is completed, when a predetermined period of time has elapsed or a predetermined input (e.g. a click of the mouse) has been detected, the operation returns to Step S1 to repeat the processes of Steps S1 through S5.

In the case of a multi-window OS, a window related to another application or service may be displayed in front of the measurement device control software window 41. Accordingly, the display of the additional GUI component should be controlled so that this component will not obstruct any window displayed in front of the measurement device control software window 41.

An operation performed by the program when a user has performed an operation on the additional GUI component using the input unit 9 is hereinafter described. For example, when a mouse-click input is made through the input unit 9, the command executer 7 refers to the additional GUI information storage section 11 and performs an operation assigned to the additional GUI component. Basically, this operation is handled as an operation directed at the measurement device control software 10, although it may be an operation directed at the computer (OS) on which the measurement device control software 10 is running. A combination of these two kinds of operations is also possible.

Specific examples of the operations which are prescribed in the additional GUI information storage section 11 and will be performed by the command executer 7 are as follows:

### Example 1

One of the menu options available in the measurement device control software 10 is automatically executed by shortcut keys. Generally, GUI-based software applications have shortcut keys assigned to the menu options. For example, on many software products designed for the Windows™ OS, the “File open” command can be executed by the key input of “Ctrl+O” or “Alt+F→O” (these key inputs are recognized as equivalent to the operation of selecting the “Open (O)” option in the “File (F)” menu).

### Example 2

A button in the measurement device control software 10 is located by an image analysis and an operation on that button is automatically executed. This is effective, for example, when the button is visually difficult to locate. The coordinates of a point included in the image of the target button within the desktop image are determined, and the point is automatically clicked. If the target button has not been found in the measurement device control software 10, auxiliary information can be displayed on the screen, such as a message informing users of the situation and/or a description of how to make the button visible.

### Example 3

A mouse-click or drag-and-drop operation for resizing the window or changing the position of a splitter is automatically performed.

### Example 4

A parameter corresponding to the content of the setting is calculated, a character string or numerical value representing the parameter value is preformatted so as to conform to the format for input into the measurement device control software 10, and the character string or numerical value is entered in a target area on the measurement device control software window 41. For example, the entry can be achieved by the “paste” operation, i.e. the transfer of information via the “clipboard” of the OS.

A specific function of the measurement device control software 10 is directly called and executed. This can be achieved in the case where the source code of the software 10 is available or application programming interfaces of the software 10 are laid open (e.g. as dynamic link libraries or COM interfaces).

When a clicking operation is performed on the additional GUI component superposed on the measurement device control software window 41, the clicking operation may be regarded as an input simply directed at that additional GUI component, or it may further be passed as a clicking operation onto the measurement device control software 10 under (behind) the additional GUI component. It is also possible to design the system in such a manner that a clicking operation on the additional GUI component is normally handled as an input simply directed at this component, but will be directly passed onto the measurement device control software 10 behind the additional GUI component, bypassing the additional GUI component, if the click operation is combined with a predetermined key operation (e.g. when the mouse is clicked with the Shift-key held down).

Although two kinds of reference images are used in the present embodiment, it is possible to use three or more reference images or merely a single reference image.

It is also possible to provide an additional GUI customizer for allowing users to customize information in or add information to the additional GUI information storage section 11, such as the reference image of the additional GUI component or the operation to be performed by the component.

Instead of previously designating the display position of the additional GUI component, it is possible to find a blank area within the measurement device control software window 41 by an image analysis and display the additional GUI component within that area after adjusting the component size (or without such an adjustment).

### Second Embodiment

In the displaying and executing operation assistance program according to the present invention, the function of the operation guide can be realized using the additional GUI. In this case, textboxes for showing descriptions and geometric frames for highlighting commands or signs included in the measurement device control software window 41 are used as the additional GUI components to be superposed on the measurement device control software window 41. Examples of the geometric frames are rectangles, circles, ellipses and leader lines for directing users' attention to the target information.

FIG. 8 is a schematic configuration diagram of the system in which the displaying and executing operation assistance program of the present embodiment is running.

The measurement control system 1 of the present embodiment has the same basic configuration as the first embodiment and additionally includes a stepwise GUI displayer 15. The stepwise GUI displayer 15 is a software component created by executing the displaying and executing operation assistance program 3.

In the case where the operation guide includes a plurality of stages, the additional GUI information storage section 11 holds the information on the additional GUI component and the reference image for each stage (as will be described later). Information on the triggering event which makes the operation guide move to the next stage is also stored in the additional GUI information storage section 11 (as will be described later).

An operation of the stepwise GUI displayer 15 is hereinafter specifically described with reference to the attached drawings. FIG. 10 is a flowchart showing an operation of the displaying and executing operation assistance program 3 according to the present embodiment.

In the present example, the measurement device 20 is a high performance liquid chromatograph (HPLC) and the measurement device control software 10 is a software application for analyzing the measurement data obtained with the HPLC.

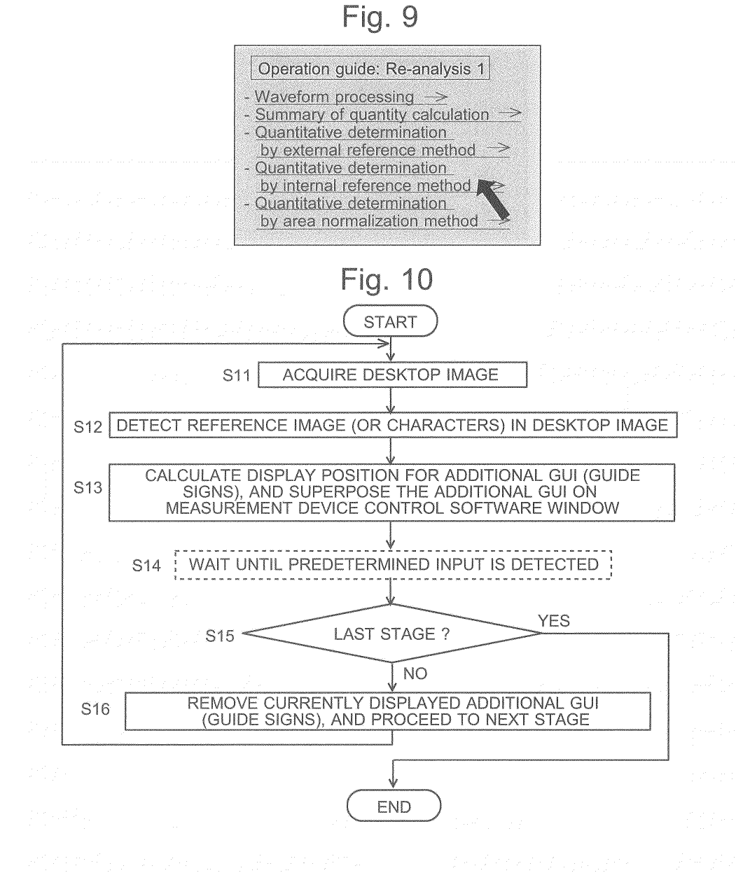

(Start) First, the user performs a predetermined operation on the input unit 9 (e.g. by clicking at a predetermined position on the measurement device control software window 41 and then pressing an “Operation Guide Start” button) to command the measurement device control software 10 to initiate the operation guide, whereupon a list of available operation guides is displayed (FIG. 9). Hereinafter, it is assumed that the user has selected an operation guide for “Quantitative determination by internal reference method” in an analysis of measurement data. In the present example, the operation guide for “Quantitative determination by internal reference method” consists of seven stages.

(Step S11) The stepwise GUI displayer 15 acquires a desktop image of the display unit 8.

(Step S12) Next, referring to the first-stage reference image stored in the additional GUI information storage section 11, the stepwise GUI displayer 15 analyzes the desktop image acquired in Step S11 to find a detection image corresponding to the reference image and determine the position of the detection image (in local or global coordinates). The reference image may be previously given as an image file or dynamically created from a given character string. Various techniques can be used for finding the detection image, such as the image matching, pattern recognition or character recognition.

In the present embodiment, an image including the character string “Method (M)” is the first-stage reference image.

(Step S13) The stepwise GUI displayer 15 refers to the additional GUI information storage section 11 and obtains the following instructions on how to display the additional GUI components to be used in the first stage of the operation guide:

(1) Draw a rectangular frame enclosing the character string “Method (M).” (This instruction should also include the position (coordinates), size, color and other properties of the frame.)

(2) Display the character string “↓ Click here” (with the non-transparent background) above the frame at a position displaced rightward from the frame by 20 pixels.

(3) Display the character string “setting window will open” (with the non-transparent background) on the right side of the frame at a position separated from the frame by 15 pixels.

Based on these instructions, the stepwise GUI displayer 15 calculates the positions of the additional GUI components (guide signs) and superposes the three components on the measurement device control software window 41 (FIG. 11).

When a clicking operation is performed within the frame through the input unit 9, the operation is recognized as being directed at the measurement device control software 10 behind the frame. That is to say, in the present stage, the event is recognized as the clicking operation on the “Method (M)” menu on the measurement device control software window 41.

(Step S14) The stepwise GUI displayer 15 refers to the additional GUI information storage section 11 and recognizes that the event which triggers the transition to the second stage is the detection of the character string “Data processing parameter (N).”

This character string appears on the measurement device control software window 41 when the user has performed a clicking operation within the frame enclosing the character string “Method (M)” through the input unit 9.

(Step S15) The stepwise GUI displayer 15 determines whether or not the guiding process is in the last (seventh) stage. At this point of the present example, since the process is in the first stage, the determination result is “No” and the process goes to Step S16.

(Step S16) The stepwise GUI displayer 15 removes the additional GUI components currently present on the display unit 8 and proceeds to the next stage of the guiding process.

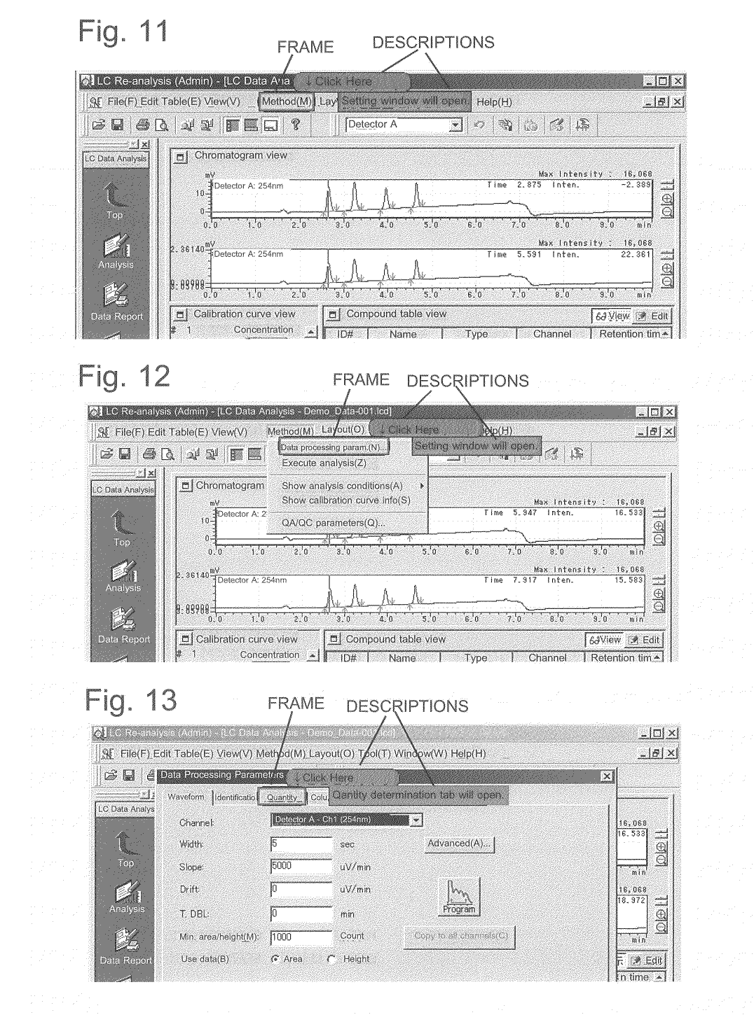

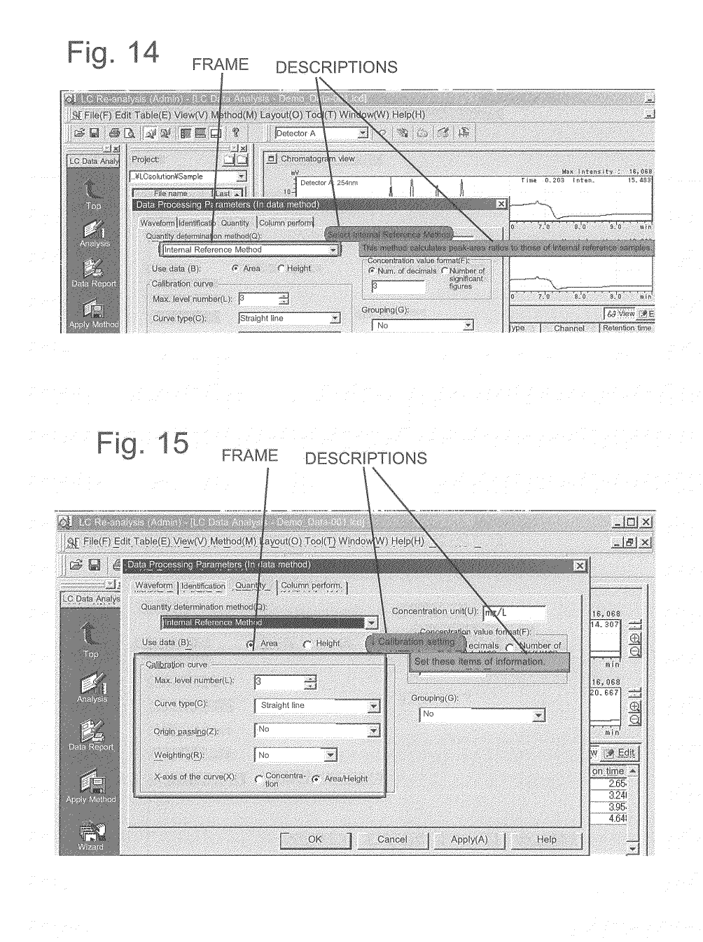

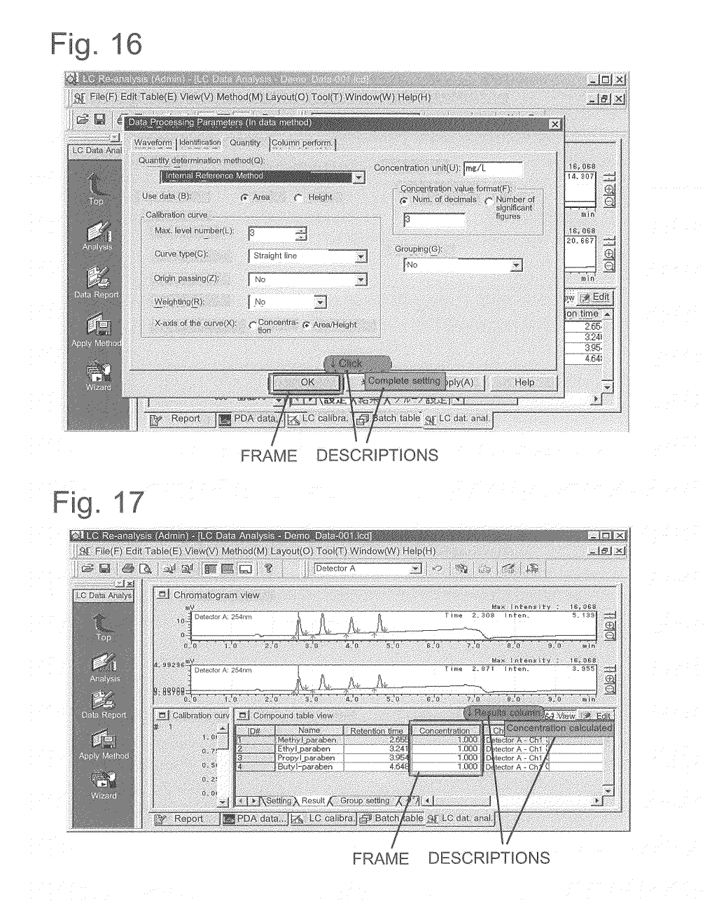

The stepwise GUI displayer 15 repeats the previously described steps (S11 through S16) until the seventh stage is completed. FIGS. 12 through 17 respectively show examples of the screen images which will be displayed in the second through seventh stages.

In the last (seventh) stage, since the determination result in Step S15 is “YES”, the stepwise GUI displayer 15 discontinues the entire process. Thus, the operation guide comes to an end.

Other possible examples of the event which triggers the transition to the next stage (in Step S14) are as follows:

### Example 1

The transition to the next stage occurs when the mouse pointer is moved over one of the guide signs (additional GUI components) or slightly later than that motion (e.g. three seconds later).

### Example 2

The transition to the next stage occurs when a predetermined mouse operation (such as the double click, right click, left click or drag operation) is performed within the frame of one of the guide signs (additional GUI components).

### Example 3

The transition to the next stage occurs when the reference image (or reference character string) of the next stage is displayed (detected) somewhere on the desktop.

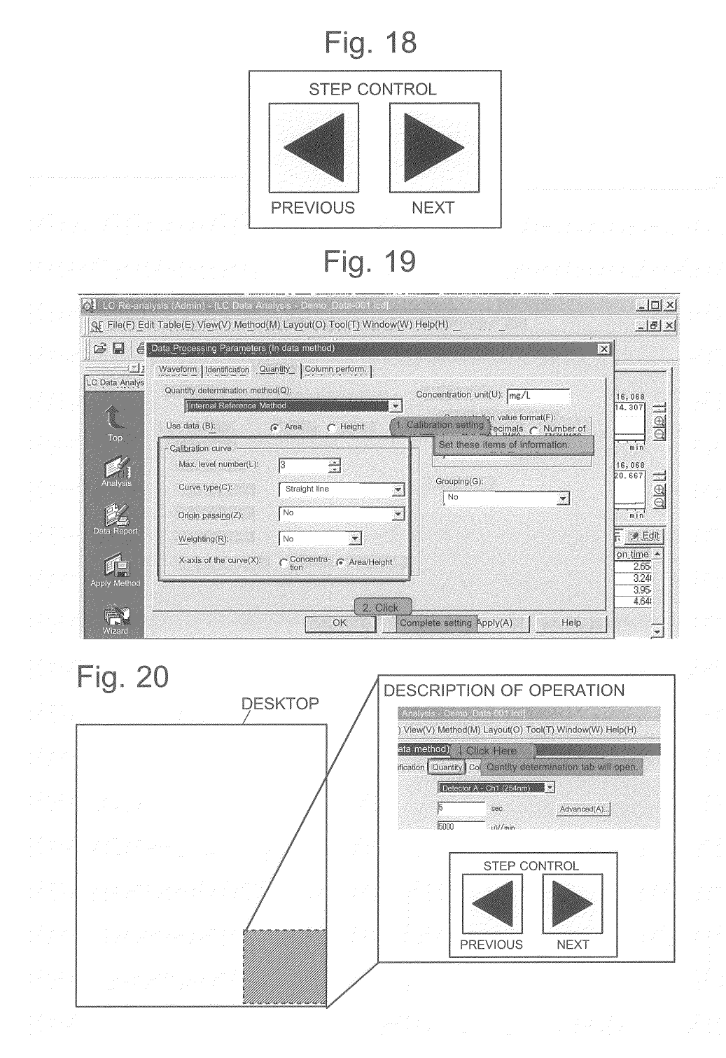

It is also possible to display a step-control panel of the operation guide with the “Next” and “Previous” buttons on the display unit 8 as shown in FIG. 18, and design the program so that the guiding process moves forward or backward when the “Next” or “Previous” button is pressed by the clicking operation.

The operation guide invoked by a command input does not always need to begin from the first stage. For example, when the user has entered the aforementioned command in the middle of a series of operations, the guiding program may analyze the current desktop image, referring to the information on the triggering event for each stage in reverse order (in descending order of the stage number) starting from the last stage, so as to find an operation guide that corresponds to the current state of the target application.

Furthermore, as shown in FIG. 19, the additional GUI components for a plurality of stages may be simultaneously displayed.

In the case where no reference image has been detected in Step S12, a graphical operation guide may be separately displayed, for example, on a blank area (or predetermined area) within the desktop, as shown in FIG. 20. Thus, an operation guide for users can be provided even if no reference image is detected.

Instead of triggering the transition to the next stage upon detecting a specific input in the previously described manner, it is possible to acquire the desktop image at regular intervals of time, determine whether or not a certain reference image (detection image) is included in the desktop image, and display additional GUI components assigned to that reference image or discontinue the entire process when the reference image has been found.

Additionally, various other functions for assisting the user's operations may also be provided, such as the operation of automatically moving the mouse pointer into the area on which the additional GUI components as the operation guide are displayed, or the operation of automatically clicking a specified GUI component and/or entering predefined characters or numbers.

If it is possible that the same reference image is detected at a plurality of locations on the desktop (as in the case where the control software 10 can simultaneously display two or more windows), additional information should preferably be stored to specify whether the additional GUI components for that reference image should be displayed at every possible location or at one specific location, and to specify the serial number (as counted from the upper-left corner of the desktop) of that specific location which should serve as the reference for the target frame. Based on this information, the operation of the stepwise GUI displayer 15 can be appropriately controlled.

The display and executing operation assistance program in any of the previous embodiments is designed for a measurement device control software. However, the display and executing operation assistance program according to the present invention is not limited to the field of measurement but can be applied to any kinds of software regardless of the technical field.

### REFERENCE SIGNS LIST

1 . . . Measurement Control System
3 . . . Displaying and Executing Operation Assistance Program
5 . . . Target Software Identifier
6 . . . Additional GUI Displayer
7 . . . Command Executer
8 . . . Display Unit
9 . . . Input Unit
10 . . . Measurement Device Control Software
11 . . . Additional GUI Information Storage Section
15 . . . Stepwise GUI Displayer
20 . . . Measurement Device
31 . . . First Reference Image
32 . . . Second Reference Image
40 . . . Desktop Image
41 . . . Measurement Device Control Software Window
51 . . . Up-Down Arrows (Additional GUI)
52 . . . Command Set (Additional GUI)

1. A non-transitory computer readable medium recording a program for assisting an operation of one or a plurality of software programs having a base graphical user interface (GUI) displayed on a screen, the program being designed to display an additional GUI component on the screen and allow an operation of a computer to be executed through the additional GUI component, the computer being capable of accessing an additional GUI information storage section in which a reference image, an image of the additional GUI component, information on a display position designated for the additional GUI component, and an operation to be performed by the additional GUI component are stored, and the program making the computer function as:
a) a reference image detector for detecting, within the base GUI displayed on the screen, a detection image which is an image that matches the reference image, and for determining a display position of the detection image;
b) a target software identifier for identifying, based on the detection image and/or information on the display position of the detection image, a target software program which is a software program showing the detection image;
c) an additional GUI displayer for superposing the image of the additional GUI component at a display position designated for the additional GUI component, with reference to the additional GUI information storage section, when the detection image is detected; and
d) a command executer for performing, on the target software program, the operation performed by the additional GUI component, with reference to the additional GUI information storage section, in response to an input operation performed on the additional GUI component by a user.

2. The non-transitory computer readable medium according to claim 1, wherein the target software identifier and the additional GUI displayer operate at predetermined intervals of time and/or based on a predetermined operation input.

3. The non-transitory computer readable medium according to claim 1, the program making the computer further function as:
a stepwise GUI displayer for performing, for each of a plurality of predetermined stages, an operation of controlling the additional GUI displayer to display an additional GUI component on a designated display position on the base GUI and an operation of moving to a next stage based on an predetermined input operation and/or at predetermined intervals of time.

4. The non-transitory computer readable medium according to claim 1, wherein:
the additional GUI component is a descriptive character string and/or a geometric frame; and
an input operation performed within the geometric frame is recognized as an operation directed at the target software behind the geometric frame.

5. The non-transitory computer readable medium according to claim 1, wherein the additional GUI displayer separately displays a description of an operation guide on a predetermined area on the screen when the detection image has not been detected.
